(19) United States
(12) Patent Application Publication
(10) Pub. No.: US 2006/0107319 A1
(43) Pub. Date: May 18, 2006

(54) Web based automated certification and accreditation (C&A) application

(76) Inventor: Ernest Lewis Smiley, Montclair, VA (US)

Correspondence Address: Ernest Smiley, 16211 S Edgewood Dr., Montclair, VA, 22026, US

(21) Appl. No.: 10/968,880

(22) Filed: Oct. 21, 2004

(51) Int. Cl. G06F 12/14

(52) U.S. Cl. 726/22

(57) ABSTRACT

A web based automated C&A application that communicates with Computer Emergency Response Team (CERT), National Institute of Standards and Technology (NIST) and Tripwire (current security organizations) to support real-time security management and processes. Without automated C&A processes, organizations have developed multiple methodologies and acquired software tools that may or may not provide the detailed guidance for systems analysis required from an information security (IS) perspective. C&A relates to the protection of information systems against unauthorized access to or modification of information, whether in storage, processing, or transit. C&A also analyzes protection against such failures as denial of service to authorized users, unauthorized access, and agency capabilities to detect and document threats. Automated certification process reduces reliance on human intervention, in addition to providing labor and cost savings.

### BACKGROUND

The lack of centralized standardization and automation of C&A processes has led the Information Technology Security community to develop separate methodologies and acquire tools that may or may not provide the detailed guidance needed to analyze systems from an information systems security perspective. Automated C&A applications assess the entire process, from information gathering through document generation. The software simplifies certification and accreditation and reduces its costs by guiding users through a step-by-step process to determine risk posture and assess network and system configuration compliance with industry best practices and national and international security regulations, policies, and standards. The application automatically engages the appropriate security requirements according to government and/or industry best practices. The software then automatically generates the appropriate test procedures, processes the test results, produces a risk assessment, and allows the user to automatically publish a complete C&A package, including all appendices, in accordance with security standards and processes.

### SUMMARY

According to an embodiment, the present software invention may provide a secure network management protocol for a computer network. The secure network management protocol may include a secure network management agent having a database/library and a plurality of data sources distributed throughout the computer network. The secure network management protocol is provided in communication with the data sources via instrumentation entities of the components.

### DETAILED DESCRIPTION

Embodiments of the present invention provides a secure network management agent for a computer network. The secure network management agent receives alerts from a plurality of data sources, harmonizes the alerts and reports harmonized alerts to an application console. SNMPS permits like-kind alerts from different instrumentation entities to be presented to a technician using similar formats.

Embodiments of the present invention provide a secure network management agent for a computer network. The secure network management agent receives alerts from a plurality of data sources, harmonizes the alerts and reports harmonized alerts to an application console.

FIG. 1 illustrates secure network management communications between TCP/IP, SNMP and SNMPS. This illustration provides a platform for communications between computer equipment, network devices and interfaces to telecommunications.

FIG. 2 provides an illustration of current SNMP technology communicating with SNMPS over an IP network. This process an integrate platform for current (HP Openview, E-Trust, Firewalls, and VPN) technology and processes to communicate with SNMPS platform.

### BRIEF DESCRIPTION OF THE DRAWINGS

FIG. 1 is a block diagram of an exemplary of secure management protocol communicating with SNMP, TCP/IP and the Internet with an embodiment of the present invention.

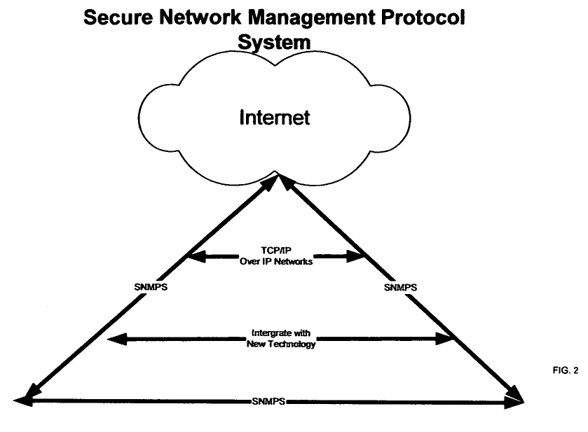

FIG. 2 is a block diagram of a secure network management protocol system communicating with TCP/IP network and new technology constructed in accordance with an embodiment of the present invention.

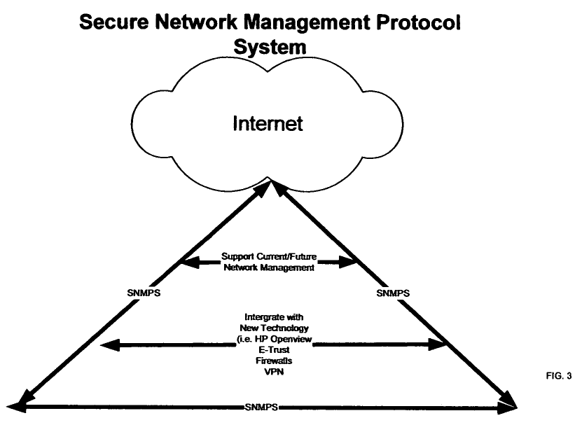

I claim:

1. A web based automated certification and accreditation application, comprising:
1. C&A protection mechanisms and safeguards that are designed and integrated into the system and/or subsystems.
2. C&A decisions that ensure against costly retrofits and delays in fielding deploying operational information systems.
